(19) United States
(12) Patent Application Publication
(10) Pub. No.: US 2026/0317079 A1
(43) Pub. Date: Oct. 15, 2026

(54) HANDLING DEVICE AND METHOD FOR HANDLING AT LEAST ONE TARGET PIECE GOOD

(71) Applicant: Körber Supply Chain Logistics GmbH, Konstanz (DE)

(72) Inventors: Marco Fischer, Konstanz (DE); Richard Huber, Konstanz (DE); Dirk-Udo Eisser, Reichenau (DE); Oliver Schulze, Überlingen (DE); Rolf-Peter Skrdlant, Überlingen (DE)

(21) Appl. No.: 19/549,431

(22) Filed: Feb. 25, 2026

(30) Foreign Application Priority Data
Feb. 26, 2025 (EP) 25160170.4

(51) Int. Cl. B65G 47/48; B65G 47/90; G06N 20/00

(52) U.S. Cl. CPC B65G 47/485; B65G 47/905; G06N 20/00; B65G 2203/0208

(57) ABSTRACT

A handling device for removing at least one target piece good from a stream of goods includes a functional end configured to grip at least one target piece good in a gripping area, wherein the functional end is configured to be displaced between a rest position and a gripping position, wherein the at least one target piece good is configured to be gripped in the gripping position, a sensor device configured to obtain or detect stream of piece good information of the stream of piece goods, a control unit configured to determine a displacement path of the functional end depending on the stream of piece good information; and a handling system for handling piece goods and a method for removing at least one target piece good from a stream of piece goods.

### BACKGROUND OF THE INVENTION

The present disclosure relates to a handling device for handling a target piece good, in particular for removing at least one target piece good from a stream of piece goods, and to a method for removing at least one target piece good from a stream of piece goods.

A handling device such as a robot can be used to remove piece goods from streams of piece goods. The streams of piece goods may be moving, in particular on a conveyor belt. Target piece goods can be removed from the stream of piece goods in a targeted manner. When the handling device approaches a target piece good, collisions with other piece goods or with other objects in the vicinity must be avoided. In particular, when the piece goods in a stream of piece goods are inhomogeneous, there may be piece goods of different sizes. Therefore, in order to avoid collisions, a safe approach path for the handling device is selected, for example by traveling in a large arc and always approaching the target piece goods from above. However, this is inefficient because the gripping process takes longer and requires a greater spatial displacement of the handling device.

Therefore, it is an object of the present invention to provide a handling device for removing at least one target piece good from a stream of piece goods, in which the handling process is accelerated and collisions are avoided.

### SUMMARY OF THE INVENTION

According to one aspect of the present disclosure, a handling device is provided for handling a target piece good, in particular for removing at least one target piece good from a stream of piece goods. The handling device may comprise a functional end designed to grip at least one target piece good in a gripping area. The functional end may be movable between a rest position and a gripping position. In the gripping position, the at least one target piece good can be gripped. The handling device may comprise a sensor device designed to obtain or detect piece good information of the stream of piece goods. The handling device may comprise a control unit designed to determine a displacement path of the functional end depending on the piece good information.

Compared to the known prior art, the subject-matter of the present disclosure provides the advantage that a displacement path of the functional end is determined individually based on the stream of piece goods. This allows unnecessarily long paths to be avoided. In other words, the displacement path can be optimized to avoid unnecessary or unnecessarily long paths. For example, in the case of piece goods in a stream of piece goods that represent a very minor obstacle, a travel path between the rest position and the gripping position can be selected directly (i.e., without traveling in an arc). This makes it possible to reduce the number of handling sides. Furthermore, by taking the piece good information into account, it is not necessary for the functional end to approach the gripping position vertically from above, but can also be realized laterally or diagonally. This makes it possible to save further time.

A handling device can be a device designed to handle piece goods. In this context, handling can mean that piece goods are physically moved in space. For example, the handling device can be a robot arm. The handling device can be a SCARA robot. The handling device can be designed to grasp piece goods individually. The handling device may be designed to move individual piece goods. In this case, the target piece good may be removed from the stream of goods. Furthermore, the target piece good may be introduced into a flow of goods. Furthermore, the target piece good of goods may also be moved within the stream of piece goods. The individual piece goods may comprise, for example, postal items. In particular, the individual piece goods may comprise parcels, small packages, small items, polybags, mailing bags, mailing rolls, and the like. A stream of piece goods may be a plurality of piece goods that are moved together in a transport direction. In other words, the stream of piece goods may be fed to a handling device or passed by it. The stream of piece goods can mean that piece goods are in motion. In other words, a stream of piece goods that is present in a gripping range of the handling device can change dynamically and transiently (e.g., move and/or shift). The gripping device can have a radius of action in which it can grip piece goods. This radius of action can be defined as a gripping range. For example, the gripping range may be provided around the handling device or only on one side of the handling device. In other words, the gripping device can reach and handle piece goods within the gripping range. The handling device cannot reach piece goods outside the gripping range. The stream of piece goods may run such that it passes through the gripping range of the handling device. The handling device may comprise a functional end designed to pick up a piece good (an example of handling). Furthermore, the handling device may also displace a piece good within the stream of piece goods (i.e., for example, pick it up and place it in another location). The functional end may be a pneumatic or mechanical functional end designed to handle a piece good. For example, the functional end may comprise a suction gripper. In addition or alternatively, the functional end may comprise a mechanical gripper. The functional end may also be referred to as an end effector. In the case where the handling device is a robot arm, the functional end may be movably arranged at an outer end of the robot arm. A target piece good may be a piece good from the plurality of piece goods from a target stream of piece goods. The target piece good may be a piece good to be handled by the handling device. The rest position of the functional end may be a position at which the functional end cannot grasp any piece goods. Furthermore, the rest position may be arranged such that the functional end does not obstruct or interfere with the stream of piece goods. The gripping position may be a position at which the functional end can grip a piece good. For example, the gripping position may be immediately adjacent to a target piece good so that the target piece good can be gripped when the functional end is activated. Furthermore, the functional end may be in direct contact with the target piece good in the gripping position. In this context, gripping can mean that the target piece goods can be moved together with the functional end. For example, the gripping position can be a position in which a suction cup provided on the functional end is arranged so close to the target piece good that the target piece good can be held on the functional end by applying negative pressure to the suction cup. The sensor device can detect stream of piece good information of the stream of piece goods. Stream of piece good information can be information and/or data that can be indicative of how the stream of piece goods is configured. For example, the stream of piece good information may be indicative of how large or what dimensions the piece goods of the stream of piece goods have. This makes it possible to detect how much space the stream of piece goods requires when it passes through the gripping range of the handling device. This makes it possible to define where the functional end can be positioned in space without colliding with the stream of piece goods. The sensor device can be a device designed to collect spatial information about the stream of piece goods. The sensor device can, for example, comprise an optical detection unit. Furthermore, the sensor device can be a scanning device that can scan the contours of the stream of piece goods and thus create a kind of map of the stream of piece goods. The transmitter device may be designed to continuously capture the stream of piece good information in real time or at intervals. This allows the stream of piece good information to be determined even when the stream of piece goods is changing rapidly. The control unit may be a computer-like device designed to receive data, process data, and issue control commands. The control unit can record and evaluate the stream of piece good information. In other words, the control unit can record spatial characteristics of the stream of piece goods and determine in which areas the functional end can be located without causing problems with the stream of piece goods. The displacement path can be indicative of a spatial position of the functional end in space. Furthermore, the displacement path can be the path between the rest position and the gripping position. Furthermore, the displacement path can also be indicative of a rest position and/or a gripping position. The handling device can thus define an individually adapted gripping process that can grip a target piece good, taking into account the stream of piece goods.

Optionally, the stream of piece goods can be transported on a conveyor device (e.g., conveyor belt). The conveyor device can be controlled based on the stream of piece good information of the stream of piece goods. This means that both the handling device and the conveyor device can be controlled in such a way that the target piece good can be handled. For example, the conveyor device can be slowed down if this is the only way to ensure that the piece good can be gripped safely. Furthermore, the conveyor device can also be accelerated in order to quickly convey a target piece good into the handling area of the handling device. Communication between the control unit and the conveyor device can be implemented via an interface, for example. This allows the control unit to control both the handling device and the conveyor device.

Optionally, the control unit can be designed to determine the rest position based on the piece good information. A rest position can be the position in which the functional end is not in motion. In other words, the rest position can be a “default position” of the handling device or the functional end. In the rest position, the functional end cannot grasp any piece good. The rest position can also be a starting position from which the gripping position is approached. It can therefore be advantageous if the rest position is close to the gripping position. The rest position can be the position in which the functional end waits to move to the next target piece good. In the rest position, however, it must be ensured that the functional end does not collide with piece goods being transported in the stream of piece goods. In the prior art, the rest position is often so far away from a theoretical gripping position that there is no interference between the piece goods and the handling device. However, if the stream of piece goods is dimensioned in such a way that a possible rest position already exists in its vicinity, this is not taken into account in the prior art. By taking into account the stream of piece good information of the present control unit, the rest position can be selected so that the gripping position can be reached efficiently (e.g., by reducing the distance travelled). This can reduce gripping times and increase the efficiency of the device.

Optionally, the sensor device is designed to obtain or record target piece good information, and preferably the control unit is designed to determine the displacement path of the functional end depending on the target piece good information and/or stream of piece good information. The displacement path can be a path that the functional end travels between the rest position and the gripping position and between the gripping position and the rest position. Furthermore, the displacement path can be a path that the functional end travels between the gripping position and a delivery position or vice versa. Here, the displacement path can also refer to only one of the two paths. The displacement path can therefore be the travel path of the functional end during operation of the handling device. The displacement path can thus be determined individually based on the stream of piece good information. For example, the functional end can be guided closer to the stream of piece goods if the stream of piece goods permits this, since the piece goods guided therein have small dimensions, for example. In other words, the functional end does not have to be moved in a large arc to the target piece good, but can take the shortest and therefore fastest route. This allows to reach the target piece good more quickly in order to grasp it. For example, the displacement path can differ in two cases, wherein in both cases the target piece good is located at exactly the same position. Only the surrounding piece goods in the stream of piece goods may be arranged differently, so that the target piece good cannot be approached in the same way. This means that the target stream of piece goods can be taken into account when the handling device is activated. If the target piece good information is also available, a displacement of the functional end can be individually adjusted from the gripping position to the rest position or a release position. For example, in the case of a large target piece good, it is necessary to raise the functional end high above the stream of goods so that the target piece good attached to the functional end can be moved without affecting or coming into contact with other piece goods in the stream of piece goods. For example, if the target piece good is correspondingly large, it may be necessary to move in a large arc over the stream of goods. If, on the other hand, the target piece good is small, the functional end can be guided relatively close to the stream of goods. This can increase the efficiency of the device, as it is not necessary to make a large arc every time, but the displacement path can be determined individually based on the target piece good information and/or the stream of piece good information. A distance between the functional end or the target piece good, which is held at the functional end, and other components or other piece goods can be referred to as a safety distance. The safety distance can be determined based on the target piece good information and/or stream piece good information.

Optionally, the control unit is designed to determine the displacement path of the functional end from the rest position to the gripping position depending on the piece good information and the target piece good information.

Optionally, the control unit is designed to determine the rest position in such a way that the displacement path between the rest position and the gripping position is minimal. This allows the rest position to be selected in such a way that the gripping process is as efficient and fast as possible. In other words, it is possible to approach the target piece good individually without having to make an unnecessarily large arc or detour. In other words, the rest position can also be in an area where the stream of piece goods is present, but where the current stream of piece goods is not expected to interfere with the functional end and/or the piece goods in the stream of piece goods. For example, the stream of piece goods can be transported on a conveyor belt. Usually, the functional end would be defined outside the conveyor belt's conveying area. However, by taking the stream of piece good information into account, the rest position can also be within the conveyor belt area. This allows, for example, gaps in a conveyor stream to be used to place the functional end (i.e., hook it in place without moving) until it is necessary to start up again with a target piece good. This allows the device to be operated more efficiently overall.

Optionally, the control unit is designed to determine the rest position in such a way that the displacement path of the functional end from the rest position to the gripping position is determined depending on the piece good information and/or the target piece good information. This allows an individually adapted displacement path to be achieved.

Optionally, the handling device is designed to move at least one target piece good from the gripping position to a target position. The target position can be the rest position or a delivery position. The rest position can coincide with the delivery position. In other words, the handling device can be designed to grip a piece good and hold it. While the handling device (in particular the functional end) holds the target piece good at the functional end, the functional end can displace to a target position. This allows the target piece good to be physically moved in space. The target position can be an end point or another delivery point for the target piece good. For example, the target position can be a position above a container or another conveyor device. This allows the target piece good to be removed from the stream of piece goods and fed to another handling device or further processing. From the target position, the functional end can be displaced back to the rest position or directly to a new gripping position. Where technically feasible, the same designs apply to the target position as to the rest position. Alternatively, a displacement path from the target position to a subsequent gripping position can be applied using the measures mentioned above. This allows a displacement from the target position to a gripping position to be realized quickly and efficiently. More specifically, when displacing the functional end from the target position to a gripping position, the target piece good information and/or the stream of piece good information can be used to individually adjust the displacement path.

Optionally, the rest position is variable. In other words, the rest position can be variable. For example, the functional end can be in a first rest position and be displaced from there to a first gripping position. After a target piece good has been picked up in the first gripping position and fed to a target position, a second rest position can be assumed that differs from the first rest position. This allows the respective rest position (which can also be the target position, for example) to be determined individually. More precisely, the rest position can be determined depending on the stream of piece good information. This allows an optimal rest position to be found after each completed gripping process. These rest positions may differ from one another.

Optionally, the target position is variable. The target position can be the position at the functional end at which a target piece good is delivered from the functional end. This target position can, for example, be selected so that the target piece good is transferred to a specific end position. Furthermore, the target position can be a position at which the target piece good is delivered (for example, this can be another conveyor device, a storage facility, a container, or the like). The target position can depend on the target piece good information. This means that the target position can be variable depending on the piece good being handled. For example, in the case of a large target piece good, the target position can be selected in such a way that the target piece good is transported to its destination with as little damage as possible. If, for example, the target piece good information indicates that the target piece good is very sensitive, the target position can be selected so that the target piece good only falls a minimal distance to its destination. If, on the other hand, the target piece good is more resistant, a greater fall distance can be accepted. This can reduce handling times and increase the throughput of the handling device.

Optionally, the stream of piece good information comprise a position of the piece goods in the stream of piece goods. In other words, the stream of piece good information may include a topography of the piece goods in a stream of piece goods. Furthermore, the stream of piece good information may be indicative of a 3D elevation profile of the piece goods in a stream of piece goods. This allows precise paths to be determined along which the functional end can move without collisions occurring between the functional end and/or target piece goods held thereon. The stream of piece good information may also include information about the stream of piece goods that is upstream of the handling area. This allows time to be gained to determine how the functional end can be moved relative to the stream of piece goods when a specific target piece good is to be grasped.

Optionally, the sensor device is designed to recognize the piece goods in the stream of piece goods, in particular optically. In other words, a vision system can be used to obtain the stream of piece good information and/or the target piece good information. Furthermore, the transmitter device can be designed to identify a target piece good. The identification of a target piece good can be achieved, for example, by capturing target piece good information. The target piece good information can comprise, for example, a recipient, dimensions, information attached to the target piece good, shape of the target piece good, condition of the target piece good, and the like. For example, piece goods of a certain shape (e.g., shipping rolls or polybags, etc.) can be sorted out of a stream of piece goods. Furthermore, damaged piece goods can be specifically sorted out. In addition, it is conceivable that piece goods of a certain size can be detected and sorted out. The sensor device can be implemented on an image-based basis. It is also conceivable that a LIDAR laser could be used to capture the stream of piece good information. In this case, only polygons could be captured, for example, in order to determine the height profile of the stream of piece goods. Furthermore, segmentation based on contrast could be used to obtain the stream of piece good information. In this case, it would primarily be possible to determine which piece goods are arranged relative to another. Overall, an elevation profile of the piece goods can thus be determined. In addition, it is conceivable that the stream of piece good information could be determined using the “depth by focus” method. Here, different focal lengths are used to obtain depth information from a two-dimensional image. This allows a 3D elevation profile of the target stream of piece goods to be determined using a conventional camera with adjustable focus. It is also conceivable that a 2D view of the stream of piece goods is sufficient to detect where piece goods are arranged. These positions can then be bypassed by the functional end, regardless of how high the piece goods are, in order to avoid collisions between the functional end and the piece good. This makes it easier to determine the stream of piece good information. This means that handling devices with lower computing power can also be provided. Furthermore, obtaining the piece good information may comprise classification, in which a classification is used to obtain stream of piece good information from the raw data obtained. For example, it is conceivable that raw data is fed as input data to a classifier, which then outputs stream of piece good information. The classification can be performed on the basis of sensor data, for example. The sensor data can comprise image data, laser data, segmentation data, or the like, for example. The classifier can comprise a learning algorithm, for example, which is designed to generate stream of piece good information as output data based on the input data. In this case, certain features in the sensor data can be used to infer the height position of the piece goods in a stream of piece goods. Such a classification can, for example, be trained to match the classifier to specific piece goods in a stream of piece goods. During such training, input training data can be used, which may comprise, for example, raw sensor data. The raw sensor data may comprise image data from a vision system. Furthermore, output training data may be used to train the classification. The output training data may comprise height positions of the piece goods assigned to the image data. This allows the classifier to be trained so that it can generate a height profile of the stream of piece goods based on image data as input data.

Optionally, the piece good information comprise dimensions of the piece goods in the stream of piece goods. In other words, the piece good information can comprise dimensions of the piece goods. This allows a 3D height profile of the stream of piece goods to be created.

Optionally, the piece good information comprise a 3D height profile of the piece goods in the stream of piece goods. This allows the topography of the stream of piece goods to be taken into account during operation of the handling device. Furthermore, knowing the dimensions of the piece goods allows the relative position of the piece goods in the stream of piece goods to be determined in relation to each other, and thus certain approach positions of the functional end can be determined individually based on the stream of piece good information. If, for example, several piece goods are close together so that a target piece good is obscured, the functional end can be controlled in such a way that a piece good obscuring the target piece goods is pushed away first and then the target piece good is contacted. This means that even disordered stream of piece goods can be handled. It is also conceivable that a 3D bulk can be handled.

Optionally, the piece good information comprise a conveyor speed of the piece goods in the stream of piece goods. This allows a displacement path of the functional end to be determined even in a moving stream of piece goods. In other words, it is possible to determine how the stream of piece goods in the handling area will be configured in the future.

Optionally, the functional end can rotate a target piece good held there during gripping. In other words, the control unit can be designed to control the functional end in such a way that a target piece good held at the functional end is rotated during a displacement. The rotation can be performed depending on the target piece good information and/or stream of piece good information. This allows, for example, other piece goods in the stream of piece goods to be bypassed in such a way that a collision is avoided. If, for example, a target piece good is held off-center at the functional end, the space required to move the target piece good from the gripping position to the target position can be adjusted, in particular reduced. The rotation of the target piece good can be determined based on the target piece good information and/or the stream of piece good information. This allows a target piece good to be rotated and moved relative to the piece goods in the stream of piece goods in such a way that a collision is avoided.

Optionally, the handling device can be designed to determine whether the target piece good changes shape during gripping. This can be achieved, for example, by measuring a current to drive the handling device and/or visually. This allows any changes in the shape of the target piece good during gripping to be taken into account. This allows target piece good information to be adjusted and prevents collisions with other piece goods in the stream of piece goods in the event of a change in shape of a target piece good after it has been gripped. For example, transport bags or similar items may change shape after being gripped. Based on the adjusted target piece good information (i.e., due to the change in shape of the target piece good), the displacement path between the gripping position and the target position can thus be individually adjusted during displacement. This effectively prevents collisions.

Optionally, the handling device can be designed to move the functional end parallel to the target piece good in a gripping position. In other words, the functional end can be moved just as quickly as the target piece good in a gripping position. This allows a target piece good to be picked out of a moving stream of piece goods. Thus, a target piece good can be picked out of a stream of piece goods conveyed, for example, by a conveyor belt.

Optionally, the piece good information includes a 2D view of the piece goods in the stream of piece goods. This means that a normal vision system can be used to obtain the stream of piece goods information. The 2D view can be used to obtain depth information about the stream of piece goods. For example, the 2D view can be evaluated more precisely to obtain further information. For example, several individual images with different focal points can be compared with each other to obtain depth information (“depth by focus”). Furthermore, the 2D view can be used together with other sensor data, such as scanning data (ultrasound, laser, LiDAR, and the like), to assign additional spatial information, such as depth information, to the 2D image information (i.e., the 2D view). This makes it easy to create a height profile of the stream of piece goods.

Optionally, the control unit is designed to additionally determine the rest position based on prediction information. The prediction information can, for example, be indicative of how a stream of piece goods will change in the near future. When creating the prediction information, factors such as a point in time (e.g., time of day or season), a current stream of piece goods, or other criteria can be taken into account in order to infer a probable future stream of piece goods. For example, it may be the case that a certain delivery of piece goods must be processed at a certain time of day. In other words, the control unit can learn that a certain volume of piece goods is present at a certain time of day. This allows repetitive events to be used as a basis for training a learning algorithm of the control unit to select a rest position based on the time of day. For example, at a time of day when there is usually only a low stream of piece goods, the rest position can be selected much closer to a conveyor system than at times when a relatively large number of piece goods are being processed and the handling area is therefore filled with piece goods. Furthermore, the type of piece goods can also be learned, as a specific piece good pattern is often followed by a specific other piece good pattern. For example, it is common for loading bridges to be filled with large piece goods first and then smaller piece goods to be loaded afterwards. Thus, when unloading, it can be concluded that if small piece goods are present in a certain pattern, there is an above-average probability that larger piece goods will have to be handled afterwards. The rest position of the functional end can thus be adjusted accordingly. In summary, the control unit can use a learning algorithm to recognize various patterns or boundary conditions, or a combination thereof, and determine predictive information based on this. This allows the handling device to adapt optimally to individual occurrences.

Optionally, the predictive information comprise information about an expected stream of piece goods. As described above, the predictive information can be indicative of a future expected stream of piece goods.

Optionally, the target piece good information may include a dimension of at least one target piece good. This allows the size of the target piece good together with the functional end to be determined. In other words, the space required for a piece good held at the functional end together with the functional end can be determined. This allows the functional end together with the target piece good held on it to be maneuvered past other piece goods or other elements in such a way that a collision is avoided, but no unnecessarily large detour has to be taken.

Optionally, the target piece good information may include a deformation of the at least one target piece good. Thus, based on various piece good properties, an expected deformation can be known from the target piece good information. This allows, for example, the detection of how a target piece good can be held at the functional end. For example, polybags are held differently at the end of a function than relatively rigid cardboard boxes. This allows any deformation of the target piece good in a gripped state to be taken into account and thus a shift from the gripping position to a target position to be adjusted accordingly in order to avoid collisions.

Optionally, the target piece good information can be determined optically and/or based on a stream from the handling device. The optical determination of target piece good information can be carried out as described above. For example, target piece good information can be obtained directly optically from image data of the target piece good. This includes, for example, surface texture, dimensions, shape, center of gravity determination, and the like. By taking into account a stream of the handling device, the force required to lift the target piece good can be determined. This allows conclusions to be drawn about weight, center of mass, and the like. This target piece good information can then be used to optimize the displacement of the target piece good held at the functional end.

Optionally, the functional end may be in contact with the at least one target piece good in the gripping position. In other words, the functional end may be in direct contact with the target piece good in the gripping position. This makes it possible for a target piece good to be handled or sucked up by a suction device, which may be arranged at the functional end. This ensures that the gripping process can be carried out safely.

Optionally, the control unit is designed to determine the displacement path of the functional end depending on fixed obstacles in the gripping area. Fixed obstacles can be adapted, for example, to parts of the handling device and/or other elements, which belong, for example, to the conveyor on which the stream of piece goods is transported. This allows collisions to be avoided. Furthermore, by taking other obstacles into account, cooperation with another automated handling device or persons in the gripping area can be realized. Thus, when working with a human user, for example, the handling device can avoid collisions with the user.

Optionally, the displacement path can be adjusted in real time. In other words, the displacement path of the functional end can be continuously adjusted. This means that changing boundary conditions can always result in a change in the displacement path. If, for example, an unexpected item or object enters the gripping range, the displacement path can be adjusted immediately in real time to avoid a collision. Furthermore, unintentional rearrangements of the stream of piece goods can block an originally intended displacement path, so that the displacement path must be adjusted. For this purpose, the sensor device can continuously record sensor data and adjust the displacement path accordingly. This allows the creation of a highly dynamic device that can adapt itself to changing boundary conditions.

Optionally, the relocation path can be adjusted at time intervals. For example, the sensor device can monitor the current status of the boundary conditions every tenth of a second. In other words, target piece good information and/or stream of piece good information can be recorded and a relocation path determined based on this. The newly determined displacement path can then be compared with the previously determined displacement path and, in the event of a deviation, the first displacement path determined can be replaced by the last displacement path determined. This allows for a computationally optimized adjustment of the displacement path.

Optionally, the functional end can comprise at least one suction gripper. The suction gripper has advantages for piece goods with a relatively soft surface. These can be gently sucked up and handled.

Optionally, the stream of piece goods can move at a speed of at least 1 m/s. This allows a high handling rate of piece goods per unit of time to be achieved. Thanks to the individual control of the handling device, target piece goods can be reliably picked out even from a stream of piece goods with a speed of at least 1 m/s.

Optionally, the sensor device is designed to capture intensity data. In the case of image data, intensity data can refer, for example, to the numerical values that represent the brightness or light intensity of a pixel in an image. This data can therefore describe how bright or dark a pixel is. In monochrome images (e.g., grayscale images), the intensity of a pixel can be represented by a single value (e.g., 0=black, 255=white in 8-bit representations). Intensities can represent the amount of light reflected or emitted by each image. In color images (e.g., RGB images), there are intensity values for each pixel for the individual color channels (red, green, blue). The values combine to define the perceived color of the pixel. This means that during image analysis and pattern recognition, the intensity data can be analyzed to identify edges, objects, or structures in images, for example. This allows it to be identified as a stream of piece goods. Furthermore, it is possible to identify where a piece good is located in the stream of piece goods and what its contours are.

Optionally, the sensor device comprises a LIDAR sensor. A LIDAR sensor (“Light Detection and Ranging”) is an optical measuring system that can measure the distance to objects using laser light and thus map the environment as a 3D point cloud. The sensor can emit laser pulses, measure the time it takes for the light to return to the sensor, and measure the distance based on this. This allows the sensor device to measure the distance to objects in the environment. A mirror can be used to deflect the laser so that the environment can be measured in a desired area. Furthermore, the intensity data from the LIDAR sensor can be evaluated to gather information about the material properties of the reflecting object (i.e., the piece good) based on the strength of the reflected signal. The LiDAR sensor can output a point cloud with 3D coordinates, X, Y, Z. This allows the LiDAR sensor to be used to create a 3D map of the stream of piece goods.

Optionally, the sensor device can be designed to determine the piece good information based on contrast, in particular by segmentation. When processing image data based on contrast, images can be divided into meaningful regions. A contrast (e.g., difference in brightness or color between neighboring pixels) can be used as a key feature. Edge-based segmentation can be used to detect edges, for example. This allows piece goods to be recognized in a stream of piece goods. Methods such as the SOBEL, KANI, and LAPLACE operators are suitable for this application. After edge detection, neighboring pixels with similar characteristics can be grouped to segment objects or regions. This enables efficient object recognition.

Optionally, the sensor device is designed to classify the piece goods in the stream of piece goods and output them as piece good information. This allows piece good information to be determined based on a previous classification. For example, a piece good class can be indicative of a specific dimension of piece goods. This allows piece goods of similar size to be assigned to the same class. The piece good information can be indicative of this class. This allows the handling device to be optimally and individually controlled based on the piece good information. The classification of the piece goods can also be determined based on other properties of the piece goods, such as surface texture, geometric center of gravity, center of mass, shape, changing shape, etc.

Optionally, the sensor device is designed to create a height profile of the piece goods in the stream of piece goods. Based on the information obtained, the sensor device or the control unit connected to it can create a height profile of the piece goods in the stream of piece goods. This allows depth data in particular to be used to obtain 3D information about the stream of piece goods. This allows the handling device to be controlled in such a way that collisions with the piece goods in the stream of piece goods are avoided.

Optionally, the functional end can be designed to adjust a displacement speed based on the stream of piece good information and/or the target piece good information during a displacement. This allows for individual displacement of the target piece good from the gripping position to the target position. For example, the handling device can slow down a displacement speed if a piece good from the stream of piece goods must first be allowed to pass before the target piece good is displaced. This allows the optimal displacement path to be achieved without unnecessary detours. At the same time, collisions with other piece goods or other structures can be avoided. Furthermore, a displacement sensitivity can also be accelerated if an approaching piece good from the stream of piece goods can cause a collision. Overall, the displacement speed can therefore be individually adapted to the circumstances at hand. For example, it is also conceivable that the displacement speed is reduced if the target piece good held at the functional end moves or shows other unwanted changes. This prevents damage to the target piece goods during displacement.

Optionally, the handling device may comprise a clearing device designed to request piece goods from the stream of piece goods based on the stream of piece good information and/or the target piece good information. This can be helpful, for example, if the target piece good is blocked by other piece goods. In this case, the clearing device can first clear (e.g., move) the interfering piece goods to the side before the functional end can grasp the target piece good. This allows a target piece good to be reliably grasped even in the case of large and three-dimensionally arranged piece goods in the stream of piece goods. The clearing device can be, for example, a pusher-like device that can displace piece goods spatially. For example, the clearing device can comprise a suction gripper or a pusher.

Optionally, the control unit may comprise a learning algorithm that can determine the displacement path. The learning algorithm can be trained based on input training data and output training data to determine a specific displacement path based on certain boundary conditions. This allows the learning algorithm to be trained for changing boundary conditions. Optionally, the control unit determines a displacement path of the functional end by means of a learning algorithm.

According to a further aspect of the present invention, a handling system for handling piece goods is provided. The handling system may comprise a handling device according to one of the above embodiments. Furthermore, the handling system may comprise a conveyor device which is designed to convey piece goods to the handling device. The conveyor device may be, for example, a conveyor belt. The conveyor belt may, for example, extend at least in sections through a gripping area of the handling device. It is also conceivable that the handling system comprises several handling devices. In this case, one handling device may, for example, serve to reposition piece goods of a stream of piece goods in such a way that a target piece good can be gripped by the second handling device. Thus, one handling device can clear the way for the functional end to the target piece good, while the other handling device can ensure that the target piece good is removed from the stream of piece goods.

According to a further aspect of the present invention, a method for removing at least one target piece good from the stream of piece goods is provided. The method may comprise receiving and detecting stream of piece good information. Furthermore, the method may comprise displacing a functional end based on the stream of piece good information, wherein the functional end is displaced between a rest position and a gripping position, wherein the at least one target piece good can be gripped in the gripping position.

Embodiments and features may be combined with each other to form new embodiments. Advantages and further developments mentioned in connection with the embodiments or features also apply analogously to the new embodiments. Advantages and configurations mentioned in connection with the device also apply analogously to the method and vice versa.

### BRIEF DESCRIPTION OF THE DRAWINGS

The following describes embodiments in detail with reference to the accompanying figures.

FIG. 1 is a schematic perspective view of a handling device according to an embodiment of the present disclosure;

FIG. 2 is a schematic side view of a part of the handling device according to an embodiment of the present disclosure;

FIG. 3a is a schematic perspective view of a device according to the prior art;

FIG. 3b to 3d are schematic side views of an embodiment according to the present disclosure; and

FIG. 4 is a schematic flowchart of a method according to an embodiment of the present disclosure.

### DETAILED DESCRIPTION OF THE PREFERRED EMBODIMENTS

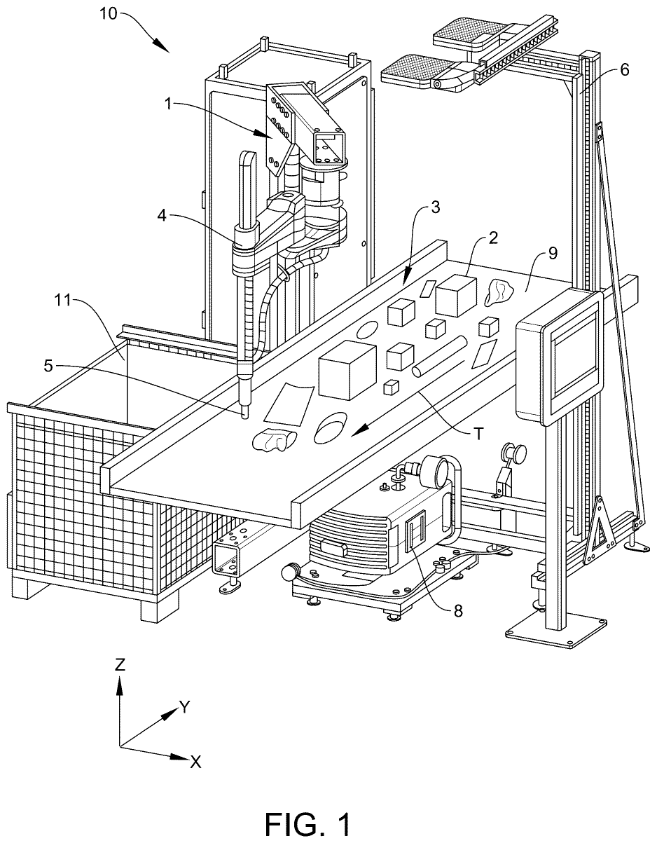

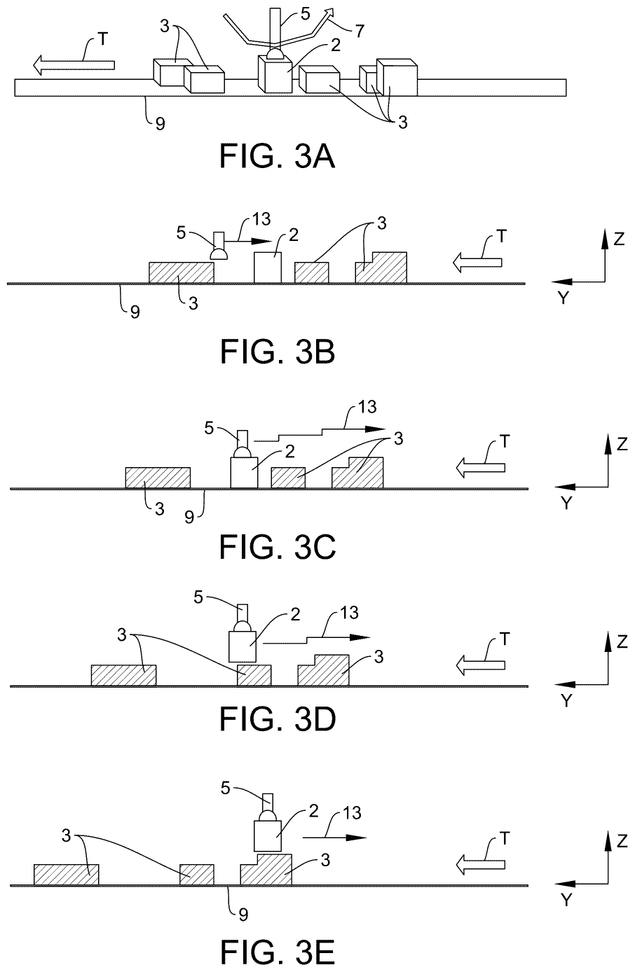

FIG. 1 is a schematic and perspective view of a handling system 10 with a handling device 1. In the present embodiment, the handling device 1 is designed as a robot arm 4. The handling device 1 comprises a functional end 5, which is designed to handle a piece good. The handling device 1 has a handling area in which the handling device 1 can handle piece goods. A transport device 9 runs through the handling area. In the present embodiment, the transport device 9 is a conveyor belt on which a plurality of piece goods is transported in the form of a stream of piece goods 3 in the transport direction T. The target piece good 2 is located in the stream of piece goods 3. The target piece good is to be transferred by the handling device 1 to a final position 11. For this purpose, the target piece good 2 is to be contacted by the functional end 5 and displaced in such a way that the target piece good 2 is reliably and efficiently fed to the final position 11. The stream of piece goods 3 comprises a plurality of piece goods of different sizes and different properties. The handling device 1 comprises a sensor device 6. The sensor device 6 is designed to detect piece good information from the stream of piece goods. In a further embodiment, the sensor device can receive stream of piece good information from an external device. In other words, an external device can detect the stream of piece good information and feed it to the sensor device 6. The handling device 1 comprises a control unit 8 which is designed to determine a displacement path 3 (see FIGS. 3A to 3D) depending on the piece good information. Thus, an individually adapted displacement path 3 can be determined, which can be described by the functional end 5, in order to feed the target piece good 2 to the final position 11.

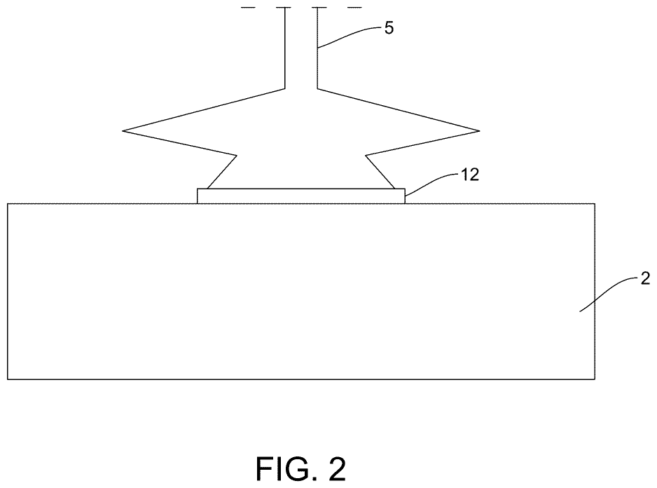

FIG. 2 is a schematic detailed view of the functional end 5 of the handling device 1 according to an embodiment of the present invention. FIG. 2 shows that, in a gripping position, the functional end 5 contacts the target piece good 2. More precisely, the functional end 5 contacts the target piece good 2 with a contact surface 12. This ensures that the target piece good 2 is satisfactorily contacted by the handling device 1 and, in particular, by the functional end 5. This ensures that the functional end 5 can satisfactorily grip and hold the target piece good.

FIG. 3a is a schematic perspective side view of a stream of piece goods being transported on a conveyor 9 in the direction of transport T. The stream of piece goods contains a target piece good 2. The target piece good 2 is to be displaced by a functional end 5. In the prior art, the functional end 5 is moved toward the target piece good in a large arc 7 and the target piece good is lifted out upwards. More precisely, the functional end 5 is also moved toward the target piece good 2 from above (always in the direction of gravity) and the target piece good 2 is then also removed in the vertical direction. This is done independently of other piece goods in the stream of piece goods. This results in unnecessarily long cycle times, as the approach and departure paths are unnecessarily long. Instead, an individually adapted path of the handling system can be taken to handle the target piece good.

According to a further embodiment not shown, the sensor device 6 can also detect only a side view of the stream of piece goods and thus control the handling device. This allows a 2D height profile of the stream of piece goods to be determined. In other words, the sensor device 6 can be designed to obtain piece good information through a side view.

FIGS. 3b to 3d describe an embodiment of the present disclosure. In FIG. 3b, it can be seen that the functional end 5 is on an access path between a rest position and a gripping position. More specifically, the functional end 5 is intended to pick up the target piece good 2 from the stream of piece goods 3. The functional end is raised vertically just high enough to pass over a piece good from the stream of piece goods 3 without contacting the piece goods. In FIG. 3c, the functional end 5 has reached the gripping position and contacts the target piece good 2. The target piece good 2 is sucked in. The target piece good 2 is then lifted and moved along a descent path or displacement path 13. FIG. 3c shows that the target piece good is lifted together with the functional end only as high in the vertical direction as necessary to lift the target piece good over adjacent piece goods from the stream of piece goods 3. FIG. 3d shows that the target piece good 2 is lifted again in the vertical direction together with the functional end 5 in order to lift the target piece good 2 together with the functional end over another piece good from the stream of piece goods. It can be seen that the piece goods are only lifted as far as necessary to lift the target piece good over other piece goods in stream of piece goods 3. This saves energy, as the target piece goods do not have to be moved unnecessarily in the vertical direction, and also allows the target piece good to be displaced more quickly.

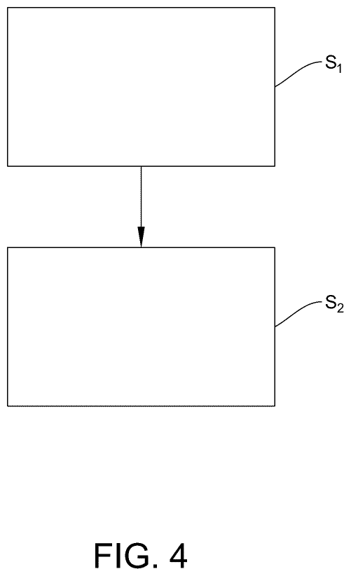

FIG. 4 is a schematic flowchart of a method according to an embodiment of the present disclosure. The method comprises, in step S1, receiving or detecting piece good information. In step S2, a functional end is displaced based on the piece good information, wherein the functional end 5 is displaced between a rest position and a gripping position, wherein the at least one target piece good can be gripped at the gripping position.

### LIST OF REFERENCE SIGNS

1 Handling device
2 Target piece goods
3 Stream of piece goods
5 Functional end
6 Sensor device
7 Displacement path from the prior art
8 Control unit
9 Transport device
10 Handling system
11 Final position
12 Contact surface
13 Displacement path

The invention claimed is:

1. A handling device for handling a target piece good and removing at least one target piece good from a stream of piece goods, comprising:
a functional end configured to grasp at least one target piece good in a gripping area, wherein the functional end is configured to be displaced between a rest position and a gripping position, wherein the at least one target piece good is configured to be grasped in the gripping position;
a sensor device configured to obtain or detect stream of piece good information of the stream of piece goods; and
a control unit configured to determine a displacement path of the functional end depending on the stream of piece good information.

2. The handling device according to claim 1, wherein the control unit is configured to determine the rest position based on the piece good information.

3. The handling device according to claim 2, wherein the rest position is variable.

4. The handling device according to claim 3, wherein the sensor device is configured to obtain or detect target piece good information, and wherein the control unit is configured to determine the displacement path of the functional end as a function of the target piece good information and/or stream of piece good information.

5. The handling device according to claim 4, wherein the stream of piece good information comprises a position of the piece goods of the stream of piece goods.

6. The handling device according to claim 5, wherein the stream of piece good information comprises a 3D height profile of the piece goods of the stream of piece goods.

7. The handling device according to claim 6, wherein the control unit is configured to additionally determine the rest position based on prediction information.

8. The handling device according to claim 1, wherein the functional end is configured to rotate the at least one piece good when the functional end is displaced with the at least one piece good from the gripping position to the target position.

9. The handling device according to claim 1, wherein the handling device is configured to determine whether the target piece good changes its shape during gripping of the target piece good.

10. The handling device according to claim 1, wherein the handling device is configured to move the functional end parallel to the target piece good in a gripping position.

11. The handling device according to claim 1, wherein the functional end is configured to adjust a displacement speed based on the stream of piece good information and/or the target piece good information during displacement.

12. The handling device according to claim 1, wherein the handling device comprises a clearing device which is configured to displace piece goods of the stream of piece goods based on the stream of piece good information and/or the target piece good information.

13. The handling device according to claim 1, wherein the control unit (8) determines a displacement path of the functional end via a learning algorithm.

14. The handling device according to claim 1, wherein the rest position is variable.

15. The handling device according to claim 1, wherein the sensor device is configured to obtain or detect target piece good information, and wherein the control unit is configured to determine the displacement path of the functional end as a function of the target piece good information and/or stream of piece good information.

16. The handling device according to claim 1, wherein the stream of piece good information comprises a position of the piece goods of the stream of piece goods.

17. The handling device according to claim 1 wherein the stream of piece good information comprises a 3D height profile of the piece goods of the stream of piece goods.

18. The handling device according to claim 1, wherein the control unit is configured to additionally determine the rest position based on prediction information.

19. A handling system for handling piece goods, comprising:
a handling device according to claim 1; and
a conveyor device configured to convey piece goods to the handling device.

20. A method for removing at least one target piece good from a stream of piece goods with a handling device according to claim 1, comprising:
receiving or detecting the stream of piece goods information;
displacing the functional end based on the stream of piece good information, wherein the functional end is displaced between the rest position and the gripping position, and wherein the at least one target piece good is configured to be gripped in the gripping position.
